(19) United States
(12) Patent Application Publication
(10) Pub. No.: US 2015/0014243 A1
(43) Pub. Date: Jan. 15, 2015

(54) Inorganic Phase Separation Membrane and the Application Thereof in Oil-Water Separation

(71) Applicants: Jihong Yu, Changchun (JP); Qiang Wen, Changchun (JP); Jiancheng Di, Changchun (CN); Cong Zhang, Changchun (CN); Ruren Xu, Changchun (CN)

(72) Inventors: Jihong Yu, Changchun (JP); Qiang Wen, Changchun (JP); Jiancheng Di, Changchun (CN); Cong Zhang, Changchun (CN); Ruren Xu, Changchun (CN)

(21) Appl. No.: 14/359,292

(22) PCT Filed: Apr. 21, 2012
(86) PCT No.: PCT/CN2012/074491

§ 371 Date: Sep. 6, 2014

(30) Foreign Application Priority Data
Mar. 29, 2012 (CN) 201210086896.0

(51) Int. Cl. B01D 69/10; B05D 1/18; B01D 71/02; B05D 3/00; B05D 3/02; B01D 67/00; B05D 1/38

(52) U.S. Cl. CPC B01D 69/10; B01D 67/00; B05D 1/18; B05D 1/38; B05D 3/007; B05D 3/0254; B01D 71/028
USPC 210/499; 427/560; 210/483

(57) ABSTRACT

An inorganic phase separation membrane and an application thereof in an oil-water separation relate to a field of a functional material technology, and more particularly to a super-hydrophilic and underwater super-oleophobic inorganic phase separation membrane with a micro-nano scale, a surface recombination, and mesh structure, wherein, a molecular sieve coating is formed on a porous substrate. The inorganic phase separation membrane can separate a variety of oils in several harsh water environments with a high efficiency, a low power loss, and a quick speed. The inorganic phase separation membrane can be used for a long time, and is easy to be reformed. The inorganic phase separation membrane of the present invention is formed by the porous substrate and the molecular sieve coating that forms on the porous substrate, wherein, an aperture size of the porous substrate is 20 μm-200 μm; a thickness range of the molecular sieve coating is 3 μm-50 μm; a mass ratio of the porous substrate to the molecular sieve coating is 100:1-5:1; the porous substrate is a stainless steel mesh, a copper mesh, an aluminum mesh, or a porous ceramic; and a framework type of the molecular sieve is LTA, SOD, FAU, MEL, CHA, MFI, DDR, AFI, BEA, or PHI.

### CROSS REFERENCE OF RELATED APPLICATION

This is a U.S. National Stage under 35 U.S.C 371 of the International Application PCT/CN2012/074491, filed Apr. 21, 2012, which claims priority under 35 U.S.C. 119(a-d) to CN 201210086896.0, filed Mar. 29, 2012.

### BACKGROUND OF THE PRESENT INVENTION

1. Field of Invention

The present invention relates to the field of functional material technology, and more particularly to a super-hydrophilic, and underwater super-oleophobic inorganic phase separation membrane with micro-nano scale, wherein molecular sieve coating is formed on the porous substrate. The inorganic phase separation membrane is widely used in oil-water separation to remove water from oil liquid.

2. Description of Related Arts

Crude oil exploitation, process of phase separation in the industrial production, treatment of oily wastewater, and leakage accidents of offshore oil occurring frequently, attract people's attention on the oil-water separation technology. At present, people have developed a variety of oil-water separation materials. Conventional oil-water separation materials developed, based on the characteristic of lipophilicity and hydrophobicity, can adsorb oil from water. However, these oil-water separation materials are easy to be polluted by oil, and are difficult to be reformed and recycled, which greatly limites the application of these oil-water separation materials. Recently, a novel oil-water separation membrane material is developed, which has the opposite infiltrating characteristic to the oil-water separation materials mentioned above. Using the special infiltrating characteristic of hydrophilic and underwater oleophobic, water can easily go through the oil-water separation membrane material, while oil is intercepted at the same time. However, because of the performance limitation of the oil-water separation membrane material developed, it is difficult for the oil-water separation membrane material to be applied in some harsh environments, such as the strong acid environment, the high ionic strength environment, the microbial contamination environment, and the high temperature environment. But in the practical application, the process of the oil-water separation is always occurred in environments mentioned above. Therefore, it is significant to develop an oil-water separation membrane material which has the infiltrating characteristic of hydrophilicity and underwater oleophobicity, and can be widely adapted in various water environments.

The molecular sieve membrane, as a new inorganic membrane, has unique advantages. The molecular sieve membrane with the stable crystal structure has good chemical stability and thermal stability; can be used in the high temperature environment, the high pressure environment, and other harsh environments; has advantages of chemical solvent resistance and biological erosion resistance.

### SUMMARY OF THE PRESENT INVENTION

An object of the present invention is to provide a cheap and simple method for preparing an inorganic phase separation membrane. A membrane material of the inorganic phase separation membrane can separate a variety of oils in several harsh water environments with a high efficiency, a low power loss, and a quick speed. The inorganic phase separation membrane can be used for a long time, and is easy to be reformed. A preparation method of the inorganic phase separation membrane is simple and easy; a cost of the preparation method of the inorganic phase separation membrane is low; is easy to be widely produced; and can be widely used in a process of an oil-water separation in various harsh environments.

The present invention provides an inorganic phase separation membrane, wherein a molecular sieve coating forms on a porous substrate. The inorganic phase separation membrane has performances of an inorganic molecular sieve, such as a chemical stability, a thermal stability, and a special infiltrating characteristic, and combines advantages of the porous substrate, such as an excellent mechanical property, and a regular porous structure. Therefore, the inorganic phase separation membrane has an extensive application prospect in an industrial production, a treatment of oily wastewater, and a treatment of leakage accidents of offshore oil.

The inorganic phase separation membrane of the present invention is formed by the porous substrate and the molecular sieve coating that forms on the porous substrate, wherein, the porous substrate is a stainless steel mesh, a copper mesh, an aluminum mesh, or a porous ceramic; an aperture size of the porous substrate is 20 μm-200 μm; a thickness range of the molecular sieve coating is 3 μm-50 μm; a framework type of the molecular sieve is LTA, SOD, FAU, MEL, CHA, MFI, DDR, AFI, BEA, or PHI; and a mass ratio of the porous substrate to the molecular sieve coating is 100:1-5:1.

Preparation methods of the inorganic phase separation membrane that relate to the present invention are described as follows.

A. Twice growth method comprises steps of:

1. dipping a porous substrate into the aqueous solution of the nano-zeolite dispersed, wherein a mass fraction of aqueous solution of nano-zeolite dispersed is 2%-10%;

processing the porous substrate with an ultrasonic treatment for 5-30 minutes;

taking out the porous substrate;

drying the porous substrate under 40° C.-200° C. for 2-12 hours;

and repeating steps of dipping, processing with the ultrasonic treatment, and drying mentioned above for 2-10 times, in such a manner that the nano-zeolite equably disperse on the porous substrate;

2. vertically fixing the porous substrate in a hydrothermal reactor;

dipping the porous substrate into synthetic sol of the nano-zeolite that is used in the Step 1;

processing the porous substrate with a hydrothermal reaction under 40° C.-230 ° C. for 2-120 hours to process the nano-zeolite with a secondary growth;

and washing, drying, and flattening the porous substrate, in such a manner that an inorganic phase separation membrane of the present invention is obtained.

B. In situ growth method comprises steps of:

vertically fixing a porous substrate in a hydrothermal reactor;

dipping the porous substrate into synthetic sol of nano-zeolite;

processing the porous substrate with a hydrothermal reaction under 40° C.-230° C. for 2-120 hours;

and washing, drying, and flattening the porous substrate, in such a manner that an inorganic phase separation membrane of the present invention is obtained.

C. Microwave twice growth method comprises steps of:

1. dipping a porous substrate into the aqueous solution of the nano-zeolite dispersed, wherein a mass fraction of aqueous solution of nano-zeolite dispersed is 2%-10%;

processing the porous substrate with an ultrasonic treatment for 5-30 minutes;

taking out the porous substrate and drying the porous substrate under 40° C.-200° C. for 2-12 hours;

and repeating steps of dipping, processing with the ultrasonic treatment, and drying mentioned above for 2-10 times, in such a manner that the nano-zeolite equably disperse on the porous substrate;

2. vertically fixing the porous substrate mentioned above in a hydrothermal reactor;

dipping the porous substrate into synthetic sol of the nano-zeolite that is used in the Step 1;

processing the porous substrate with a microwave heating under 60° C.-200° C. to react for 30-300 minutes;

and washing, drying, and flattening the porous substrate, in such a manner that an inorganic phase separation membrane of the present invention is obtained.

D. Microwave in situ growth method comprises steps of:

vertically fixing a porous substrate in a hydrothermal reactor;

dipping the porous substrate into synthetic sol of nano-zeolite;

processing the porous substrate with a microwave heating under 60° C.-200° C. to react for 30-300 minutes;

and washing, drying, and flattening the porous substrate, in such a manner that an inorganic phase separation membrane of the present invention is obtained.

E. Vapor phase transport method comprises steps of:

1. vertically fixing a porous substrate in a hydrothermal reactor;

dipping the porous substrate into synthetic sol of nano-zeolite for 2-48 hours; taking out the porous substrate;

drying the porous substrate under 20° C.-100° C. for 2-72 hours;

and repeating processes of dipping, and drying mentioned above for 2-10 times;

2. putting the porous substrate processed mentioned above in vapor phase with solvent and organic amine;

reacting the porous substrate under 80° C.-230° C. for 2-72 hours;

and washing, drying, and flattening the porous substrate, in such a manner that an inorganic phase separation membrane of the present invention is obtained.

Oil-water separation experiment is described as follows.

1. An experimental installation as shown in FIG. 4b, an inorganic phase separation membrane is fixed on polytetrafluoroethylene (PTFE) flange that is shown in FIG. 4a; the PTFE flange of the inorganic phase separation membrane fixed is put on a flask, wherein the flask is 250 ml; a glass tube is connected on the flask, wherein, an outer diameter of the glass tube is 30 mm, and a length of the glass tube is 20 cm; and the flask is sealed by a tetrafluoroethylene (TFE) sealing tape.

2. Water phase and oil phase are mixed, and the water phase and the oil phase are mixed to be mixture, wherein the water phase occupies 5%-95% of a total volume of the mixture.

3. After stirring the mixture in a high speed, the mixture is poured into the glass tube of the experimental installation of the oil-water separation experiment that is shown in FIG. 4b, and the water phase rapidly flows into the flask.

4. After the water phase all flows into the flask, the oil phase is intercepted by an inorganic phase separation membrane, so that the oil phase cannot flow into the flask. A liquid level of the glass tube no longer decreases, after a condition that the liquid level of the glass tube no longer decreases keeps stably for 30 minutes, the inorganic phase separation membrane is considered to separate the water phase and the oil phase successfully. The oil phase is poured out from a top of the glass tube; and is mixed with the water phase separated again. The inorganic phase separation membrane is used continuously without any processing to repeat the separating process mentioned above for 10 times, and an oil-water separation performance of the inorganic phase separation membrane is not affected.

Preferably, the oil phase in the experiment mentioned above is selected from a group consisting of petroleum, rapessed oil, gasoline, diesel fuel, petroleum ether, cyclohexane, n-heptane, n-octane, n-butanol, ethyl acetate, benzene, dichloroethane, and chloroform, which are low-polarity solvents insoluble in water, in such a manner that a separation effect thereof is not affected.

Preferably, the water phase in the experiment mentioned above is selected from a group consisting of aqueous solution of hydrochloric acid, aqueous solution of sulfuric acid, aqueous solution of nitric acid, aqueous solution of sodium hydroxide, aqueous solution of potassium hydroxide, aqueous solution of sodium chloride, aqueous solution of potassium chloride, aqueous solution of copper chloride, aqueous solution of ferric chloride, and aqueous solution of copper sulfate, which are pure aqueous solution or mixed aqueous solution.

Preferably, a mass fraction of total solute of the water phase solution mentioned above is 1%-65%, and a separation property thereof is not affected.

These and other objectives, features, and advantages of the present invention will become apparent from the following detailed description, the accompanying drawings, and the appended claims.

### BRIEF DESCRIPTION OF THE DRAWINGS

FIG. 1 is a photograph of a surface of an inorganic phase separation membrane that is scanned by a high resolution scanning electron microscope, according to Example 2 of the present invention, wherein a composite surface in a micro-nano scale that is formed by silicalite-1 crystal can be seen clearly.

FIG. 2 is a XRD spectrogram of the inorganic phase separation membrane that is processed with a twice hydrothermal growth, according to the Example 2 of the present invention, which confirms a MFI structure of the inorganic phase separation membrane.

FIG. 3 (a) is a photo of contact angle that is formed by the inorganic phase separation membrane and 1,2-dichloroethane in air, wherein the inorganic phase separation membrane is processed with the twice hydrothermal growth in the Example 2 of the present invention. The 1,2-dichloroethane fully spreads on the inorganic phase separation membrane to form a contact angle, and the contact angle is smaller than 5°, which confirms that the inorganic phase separation membrane has a super-lipophilic property in the air.

FIG. 3 (b) is the photo of contact angle that is formed by the inorganic phase separation membrane and water drop in the air, wherein the inorganic phase separation membrane is processed with the twice hydrothermal growth in the Example 2 of the present invention. The water drop fully spreads on the inorganic phase separation membrane to form the contact angle, and the contact angle is smaller than 5°, which confirms that the inorganic phase separation membrane has a super-hydrophilic property in the air.

FIG. 3 (c) is the photo of contact angle that is formed by the inorganic phase separation membrane and the 1,2-dichloroethane in water, wherein the inorganic phase separation membrane is processed with the twice hydrothermal growth in the Example 2 of the present invention. The 1,2-dichloroethane keeps in a mellow droplet form to contact on the inorganic phase separation membrane that is dipped in the water to form the contact angle, and the contact angle is 160°, which confirms that the inorganic phase separation membrane has a super-oleophobic property in the water.

FIG. 4 (a) is a photo of a material object that is formed by the inorganic phase separation membrane and polytetrafluoroethylene (PTFE) flange of a separation installation, wherein the inorganic phase separation membrane is processed with the twice hydrothermal growth in the Example 2 of the present invention.

FIG. 4 (b) is a photo of an oil-water separation installation that is used in the present invention.

FIG. 4 (c) is a photo of a separation experiment in a separation process, according to Example 11 of the present invention.

FIG. 4 (d) is a photo of the separation experiment that is finished stably, according to the Example 11 of the present invention.

FIG. 5 (a) is a schematic view of a separation process of aqueous solution of hydrochloric acid (2 mol/L) and crude oil (an upper part), according to Example 16 of the present invention. After the separation process is finished, test solution of purple litmus is dripped into the aqueous solution of the hydrochloric acid separated, and a red is shown immediately (a lower part), which proves that the aqueous solution of the hydrochloric acid separated is acid.

FIG. 5 (b) is the schematic view of a separation process of aqueous solution of copper chloride (15%) and the crude oil (an upper part), according to Example 17 of the present invention. After the separation process is finished, aqueous solution of sodium hydroxide is dripped into the aqueous solution of the copper chloride separated, and a blue flocculent precipitate is shown immediately (a lower part), which proves that the aqueous solution of the copper chloride separated comprises copper ion.

FIG. 5 (c) is the schematic view of a separation process of aqueous solution of sodium chloride (10%) and the crude oil (an upper part), according to Example 18 of the present invention. After the separation process is finished, silver nitrate solution is dripped into the aqueous solution of the sodium chloride separated, and a white flocculent precipitate is shown immediately (a lower part), which proves that the aqueous solution of the sodium chloride separated comprises chloride ion.

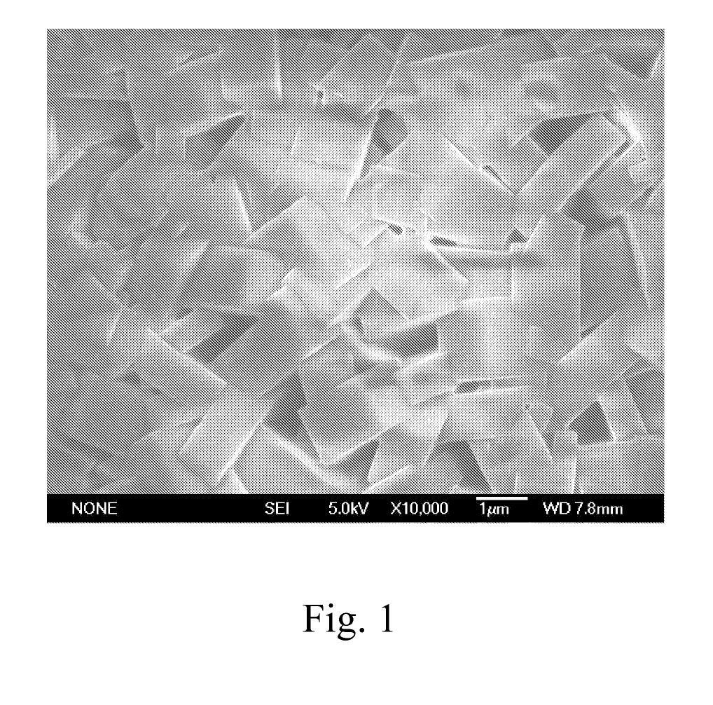

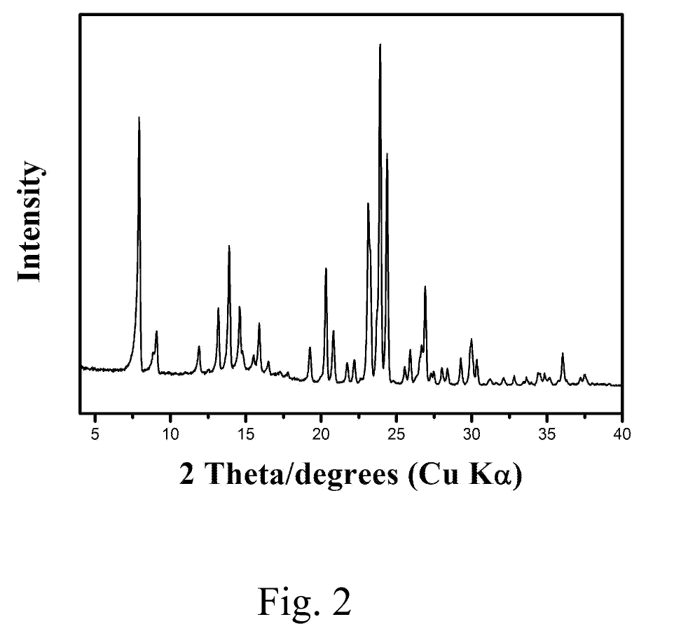

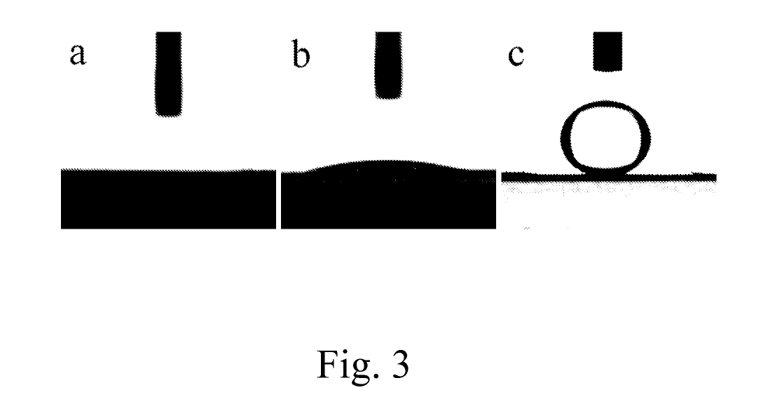

### DETAILED DESCRIPTION OF THE PREFERRED EMBODIMENT

The present is further described by Examples, but modes of executions of the present invention are not limited, which cannot be understood as limitations of protection scopes of the present invention.

### Example 1

A stainless steel mesh (80 mesh) is dipped into aqueous solution of silicalite-1 nano-zeolite dispersed (a nano-zeolite synthesis refers to Chem. Mater 20, 2008, 3543-3545), wherein, the silicalite-1 nano-zeolite is a pure silicon MIF-type molecular sieve, and a mass fraction of the aqueous solution of the silicalite-1 nano-zeolite is 2%. The stainless steel mesh is processed with an ultrasonic treatment for 10 minutes, and is dried under 180° C. for 2 hours. Steps of dipping, processing with the ultrasonic treatment, and drying are repeated for 3 times.

The stainless steel mesh processed is vertically put in a hydrothermal reactor, and is dipped into synthetic sol of silicalite-1 molecular sieve, wherein a molar ratio of the synthetic sol of the silicalite-1 molecular sieve is 1KOH:1TPABr:1000H₂O:4.4TEOS. The stainless steel mesh processed is processed with a hydrothermal reaction under 200° C. for 120 hours to process molecular sieve with a secondary growth, in such a manner that a thickness of silicalite-1 molecular sieve coating obtained is 50 μm, and a mass ratio of the stainless steel mesh to the silicalite-1 molecular sieve coating obtained is 5:1.

The silicalite-1 molecular sieve coating obtained is washed for twice by deionized water, is dried under 60° C. for 24 hours, and is flattened, in such a manner that an inorganic phase separation membrane is obtained, which can separate a variety of oils with a high efficiency and a low power loss under various kinds of harsh water environments.

### Example 2

A stainless steel mesh (360 mesh) is dipped into aqueous solution of silicalite-1 nano-zeolite dispersed (a nano-zeolite synthesis refers to Chem. Mater 20, 2008, 3543-3545), wherein, the silicalite-1 nano-zeolite is a pure silicon MIF-type molecular sieve, and a mass fraction of the aqueous solution of the silicalite-1 nano-zeolite is 2%. The stainless steel mesh is processed with an ultrasonic treatment for 10 minutes, and is dried under 180° C. for 2 hours. Steps of dipping, processing with the ultrasonic treatment, and drying are repeated for 3 times.

The stainless steel mesh processed is vertically put in a hydrothermal reactor, and is dipped into synthetic sol of silicalite-1 molecular sieve, wherein a molar ratio of the synthetic sol of the silicalite-1 molecular sieve is 1KOH:1TPABr:1000H₂O:4.4 TEOS. The stainless steel mesh processed is processed with a hydrothermal reaction under 200° C. for 72 hours to process the silicalite-1 molecular sieve with a secondary growth, in such a manner that a thickness of silicalite-1 molecular sieve coating obtained is 18 μm, and a mass ratio of the stainless steel mesh to the silicalite-1 molecular sieve coating obtained is 25:1.

The silicalite-1 molecular sieve coating obtained is washed for twice by deionized water, is dried under 60° C. for 24 hours, and is flattened, in such a manner that an inorganic phase separation membrane is obtained, which can separate a variety of oils with a high efficiency and a lower power loss under various kinds of harsh water environments.

### Example 3

A stainless steel mesh (800 mesh) is dipped into aqueous solution of silicalite-1 nano-zeolite dispersed (a nano-zeolite synthesis refers to Chem. Mater 20, 2008, 3543-3545), wherein, the silicalite-1 nano-zeolite is a pure silicon MIF-type molecular sieve, and a mass fraction of the aqueous solution of the silicalite-1 nano-zeolite is 2%. The stainless steel mesh is processed with an ultrasonic treatment for 10 minutes, and is dried under 180° C. for 2 hours. Steps of dipping, processing with the ultrasonic treatment, and drying are repeated for 3 times.

The stainless steel mesh processed is vertically put in a hydrothermal reactor, and is dipped into synthetic sol of silicalite-1 molecular sieve, wherein a molar ratio of the synthetic sol of the silicalite-1 molecular sieve is 1KOH:1TPABr:1000H₂O:4.4 TEOS. The stainless steel mesh processed is processed with a hydrothermal reaction under 200° C. for 12 hours to process the silicalite-1 molecular sieve with a secondary growth, in such a manner that a thickness of silicalite-1 molecular sieve coating obtained is 7 μm, and a mass ratio of the stainless steel mesh to the silicalite-1 molecular sieve coating obtained is 100:1.

The silicalite-1 molecular sieve coating obtained is washed for twice by deionized water, is dried under 60° C. for 24 hours, and is flattened, in such a manner that an inorganic phase separation membrane is obtained, which can separate a variety of oils with a high efficiency and a lower power loss under various kinds of harsh water environments.

### Example 4

A copper mesh (400 mesh) is dipped into aqueous solution of silicalite-1 nano-zeolite dispersed (a nano-zeolite synthesis refers to Chem. Mater 20, 2008, 3543-3545), wherein, the silicalite-1 nano-zeolite is a pure silicon MIF-type molecular sieve, and a mass fraction of the aqueous solution of the silicalite-1 nano-zeolite is 2%. The copper mesh is processed with an ultrasonic treatment for 10 minutes, and is dried under 180° C. for 2 hours. Steps of dipping, processing with the ultrasonic treatment, and drying are repeated for 3 times.

The copper mesh processed is vertically put in a hydrothermal reactor, and is dipped into synthetic sol of silicalite-1 molecular sieve, wherein a molar ratio of the synthetic sol of the silicalite-1 molecular sieve is 1KOH:1TPABr:1000H₂O:4.4TEOS. The copper mesh processed is processed with a hydrothermal reaction under 200° C. for 60 hours to process the silicalite-1 molecular sieve with a secondary growth, in such a manner that a thickness of silicalite-1 molecular sieve coating obtained is 15 μm, and a mass ratio of the copper mesh to the silicalite-1 molecular sieve coating obtained is 40:1.

The silicalite-1 molecular sieve coating obtained is washed for twice by deionized water, is dried under 60° C. for 24 hours, and is flattened, in such a manner that an inorganic phase separation membrane is obtained, which can separate a variety of oils with a high efficiency and a lower power loss under various kinds of harsh water environments.

### Example 5

A stainless steel mesh (360 mesh) is dipped into aqueous solution of silicalite-1 nano-zeolite dispersed (a nano-zeolite synthesis refers to Chem. Mater 20, 2008, 3543-3545), wherein, the silicalite-1 nano-zeolite is a pure silicon MIF-type molecular sieve, and a mass fraction of the aqueous solution of the silicalite-1 nano-zeolite is 2%. The stainless steel mesh is processed with an ultrasonic treatment for 10 minutes, and is dried under 180° C. for 2 hours. Steps of dipping, processing with the ultrasonic treatment, and drying are repeated for 3 times.

The stainless steel mesh processed is vertically put in a microwave reactor, and is dipped into synthetic sol of silicalite-1 molecular sieve, wherein a molar ratio of the synthetic sol of the silicalite-1 molecular sieve is 1KOH:1TPABr:1000H₂O:4.4TEOS. The stainless steel mesh processed is processed with a microwave heating in 300 W power (2.45 GHz) under 200° C. to react for 4 hours to process the silicalite-1 molecular sieve with a secondary growth, in such a manner that a thickness of silicalite-1 molecular sieve coating obtained is 18 μm, and a mass ratio of the stainless steel mesh to the silicalite-1 molecular sieve coating obtained is 25:1.

The silicalite-1 molecular sieve coating obtained is washed, is dried, and is flattened, in such a manner that an inorganic phase separation membrane is obtained, which can separate a variety of oils with a high efficiency and a lower power loss under various kinds of harsh water environments.

Example 6

A stainless steel mesh (360 mesh) is vertically put in a microwave reactor, and is dipped into synthetic sol of silicalite-1 molecular sieve, wherein a molar ratio of the synthetic sol of the silicalite-1 molecular sieve is 0.27TPAOH:1.0TEOS:118H₂O. The stainless steel mesh is processed with a hydrothermal reaction under 165° C. for 84 hours, in such a manner that a thickness of silicalite-1 molecular sieve coating obtained is 16 μm, and a mass ratio of the stainless steel mesh to the silicalite-1 molecular sieve coating obtained is 30:1.

The silicalite-1 molecular sieve coating obtained is washed for twice by deionized water, is dried under 60° C. for 24 hours, and is flattened, in such a manner that an inorganic phase separation membrane is obtained, which can separate a variety of oils with a high efficiency and a lower power loss under various kinds of harsh water environments.

### Example 7

A stainless steel mesh is vertically put in a microwave reactor, and is dipped into synthetic sol of silicalite-1 molecular sieve, wherein a molar ratio of the synthetic sol of the silicalite-1 molecular sieve is 0.27TPAOH:1.0TEOS:118H₂O. The stainless steel mesh is processed with a microwave heating in 250 W power (2.45 GHz) under 165° C. to react for 5 hours, in such a manner that a thickness of silicalite-1 molecular sieve coating obtained is 16 μm, and a mass ratio of the stainless steel mesh to the silicalite-1 molecular sieve coating obtained is 30:1.

The silicalite-1 molecular sieve coating obtained is washed for twice by deionized water, is dried under 60° C. for 24 hours, and is flattened, in such a manner that an inorganic phase separation membrane is obtained, which can separate a variety of oils with a high efficiency and a lower power loss under various kinds of harsh water environments.

### Example 8

A stainless steel mesh (360 mesh) is dipped into aqueous solution of NaA nano-zeolite dispersed (a nano-zeolite synthesis refers to Adv. Mater. 2005, 17, 2010-2014), wherein, the NaA nano-zeolite is a LTA-type molecular sieve, and a mass fraction of the aqueous solution of the NaA nano-zeolite is 2%. The stainless steel mesh is processed with an ultrasonic treatment for 10 minutes, and is dried under 180° C. for 60 minutes. Steps of dipping, processing with the ultrasonic treatment, and drying are repeated for 3 times.

The stainless steel mesh processed is vertically put in a hydrothermal reactor, and is dipped into synthetic sol of NaA molecular sieve, wherein a molar ratio of the synthetic sol of the NaA molecular sieve is 1.12 SiO₂:1Al₂O₃:2.55Na₂O:1800H₂O. The stainless steel mesh processed is processed with a hydrothermal reaction under 85° C. for 36 hours to process the NaA molecular sieve with a secondary growth, in such a manner that a thickness of NaA molecular sieve coating obtained is 17 μm, and a mass ratio of the stainless steel mesh to the NaA molecular sieve coating obtained is 20:1.

The NaA molecular sieve coating obtained is washed for twice by deionized water, is dried under 60° C. for 24 hours, and is flattened, in such a manner that an inorganic phase separation membrane is obtained, which can separate a variety of oils with a high efficiency and a lower power loss under various kinds of harsh water environments.

### Example 9

A stainless steel mesh (360 mesh) is dipped into aqueous solution of NaY nano-zeolite dispersed (a nano-zeolite synthesis refers to Ind. Eng. Chem. Res. 2005, 44, 937-944), wherein a mass fraction of the aqueous solution of the NaY nano-zeolite is 2%. The stainless steel mesh is processed with an ultrasonic treatment for 10 minutes, and is dried under 60° C. for 24 hours. Steps of dipping, processing with the ultrasonic treatment, and drying are repeated for 3 times.

The stainless steel mesh processed is vertically put in a hydrothermal reactor, and is dipped into synthetic sol of NaY molecular sieve, wherein a molar ratio of the synthetic sol of the NaA molecular sieve is 10.7SiO₂:1Al₂O₃:18.8Na₂O:850H₂O. The stainless steel mesh processed is processed with a hydrothermal reaction under 85° C. for 36 hours to process the NaY molecular sieve with a secondary growth, in such a manner that a thickness of NaY molecular sieve coating obtained is 17 μm, and a mass ratio of the stainless steel mesh to the NaY molecular sieve coating obtained is 20:1.

The NaY molecular sieve coating obtained is washed for twice by deionized water, is dried under 60° C. for 24 hours, and is flattened, in such a manner that an inorganic phase separation membrane is obtained, which can separate a variety of oils with a high efficiency and a lower power loss under various kinds of harsh water environments.

### Example 10

A stainless steel mesh is dipped into sol of silicon source and aluminum source of a MFI-type molecular sieve for 24 hours, wherein a molar ratio of the sol of the silicon source and the aluminum source of the MFI-type molecular sieve is 25SiO₂:1Al₂O₃:10Na₂O:500H₂O. The stainless steel mesh is took out, and is dried under 90° C. for 6 hours.

The stainless steel mesh processed is vertically put in a hydrothermal reactor, and is reacted in vapor phase that is formed by triethylamine and ethylenediamine under 180° C. for 36 hours, wherein a volume ratio of the triethylamine and the ethylenediamine is 1:1, in such a manner that a thickness of silicalite-1 molecular sieve coating obtained is 16 μm, and a mass ratio of the stainless steel mesh to the silicalite-1 molecular sieve coating obtained is 30:1.

The silicalite-1 molecular sieve coating obtained is washed for twice by deionized water, is dried under 60° C. for 24 hours, and is flattened, in such a manner that an inorganic phase separation membrane is obtained, which can separate a variety of oils with a high efficiency and a lower power loss under various kinds of harsh water environments.

### Example 11

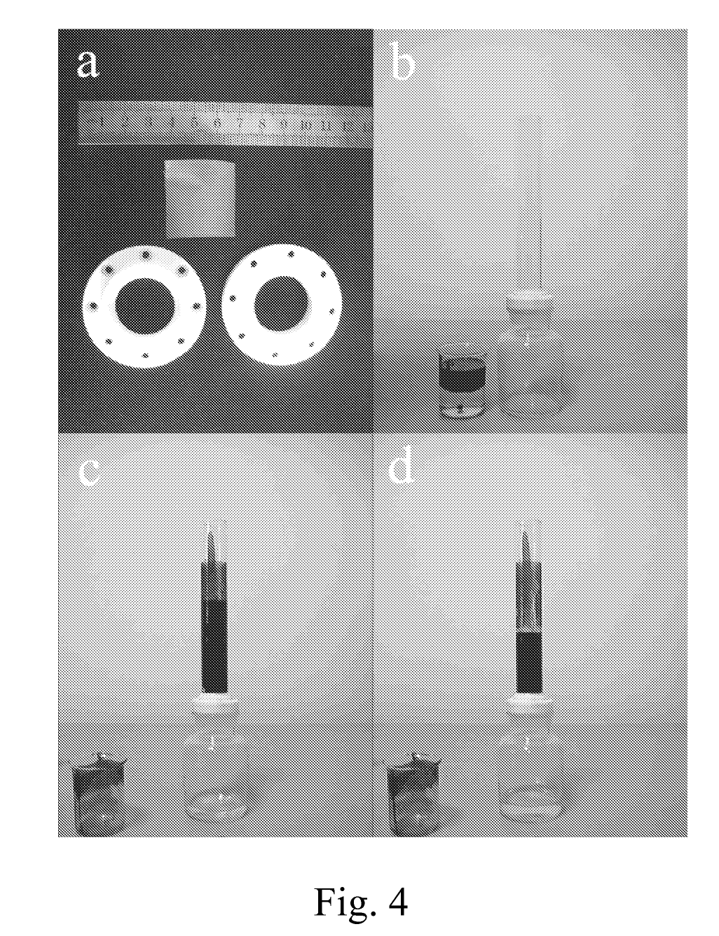

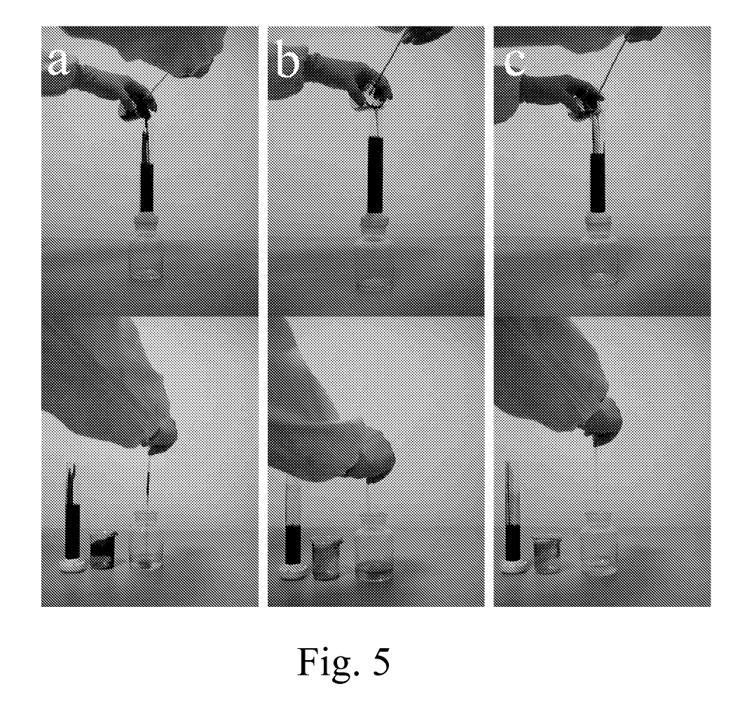

The inorganic phase separation membrane prepared in the Example 2 is fixed on a polytetrafluoroethylene (PTFE) flange that is shown in FIG. 4a. Assembling a separation installation as shown in FIG. 4b, the PTFE flange that is fixed with the inorganic phase separation membrane is put on a flask of 250 ml. A glass tube is connected on the flask, wherein, an outer diameter of the glass tube is 30 mm, and a length of the glass tube is 20 cm. The flask is sealed by a tetrafluoroethylene (TFE) sealing tape. After stirring mixture of water and crude oil, wherein a volume ratio of the water to the crude oil is 1:1, the mixture of the water and the crude oil is poured into the separation installation. The water rapidly flows down through the inorganic phase separation membrane, and the crude oil is intercepted above the inorganic phase separation membrane. Stabilizing for 30 minutes, if the water does not drop down, and the oil does not permeate, the water and the crude oil are considered to be separated fully. A separating process and a separating result see FIG. 4c and FIG. 4d.

### Example 12

The inorganic phase separation membrane prepared in the Example 2 are used without any processing to repeat the experiment of the separating process in the Example 11 for 10 times, and a property of the oil-water separation is not affected.

### Example 13

The inorganic phase separation membrane prepared in the Example 2 is fixed on a polytetrafluoroethylene (PTFE) flange that is shown in FIG. 4a. Assembling a separation installation as shown in FIG. 4b, after stirring mixture of water and crude oil, wherein a volume ratio of the water to the crude oil is 1:19, the mixture of the water and the crude oil is poured into the separation installation. The water rapidly flows down through the inorganic phase separation membrane, and the crude oil is intercepted above the inorganic phase separation membrane. Stabilizing for 30 minutes, if the water does not drop down, and the oil does not permeate, the water and the crude oil are considered to be separated fully.

### Example 14

The inorganic phase separation membrane prepared in the Example 2 is fixed on a polytetrafluoroethylene (PTFE) flange that is shown in FIG. 4a. Assembling a separation installation as shown in FIG. 4b, stirring mixture of water and crude oil, wherein a volume ratio of the water to the crude oil is 19:1, the mixture of the water and the crude oil is poured into the separation installation. The water rapidly flows down through the inorganic phase separation membrane, and the crude oil is intercepted above the inorganic phase separation membrane. Stabilizing for 30 minutes, if the water does not drop down, and the oil does not permeate, the water and the crude oil are considered to be separated fully.

### Example 15

The inorganic phase separation membrane prepared in the Example 2 is fixed on a polytetrafluoroethylene (PTFE) flange that is shown in FIG. 4a. Assembling a separation installation as shown in FIG. 4b, after stirring mixture of cyclohexane and water, wherein a volume ratio of the cyclohexane to the water is 1:1, the mixture of the cyclohexane and the water is poured into the separation installation. The water rapidly flows down through the inorganic phase separation membrane, and the cyclohexane is intercepted above the inorganic phase separation membrane. Stabilizing for 30 minutes, if the water does not drop down, and the cyclohexane does not permeate, the water and the cyclohexane are considered to be separated fully.

### Example 16

The inorganic phase separation membrane prepared in the Example 2 is fixed on a polytetrafluoroethylene (PTFE) flange that is shown in FIG. 4a. Assembling a separation installation as shown in FIG. 4b, after stirring mixture of crude oil and aqueous solution of hydrochloric acid (2 mol/L), wherein a volume ratio of the crude oil to the aqueous solution of the hydrochloric acid is 1:1, the mixture of the crude oil and the aqueous solution of the hydrochloric acid is poured into the separation installation. The aqueous solution of the hydrochloric acid rapidly flows down through the inorganic phase separation membrane, and the crude oil is intercepted above the inorganic phase separation membrane. Stabilizing for 30 minutes, if the aqueous solution of the hydrochloric acid does not drop down, and the crude oil does not permeate, the aqueous solution of the hydrochloric acid and the crude oil are considered to be separated fully. After completing the separation, test solution of purple litmus is dripped into the aqueous solution of the hydrochloric acid separated, and a red is shown immediately, which proves that the aqueous solution of the hydrochloric acid separated is an acidity.

### Example 17

The inorganic phase separation membrane prepared in the Example 2 is fixed on a polytetrafluoroethylene (PTFE) flange that is shown in FIG. 4a. Assembling a separation installation as shown in FIG. 4b, after stirring mixture of crude oil and aqueous solution of copper chloride, wherein, a volume ratio of the crude oil to the aqueous solution of the copper chloride is 1:1, and a mass fraction of the copper chloride aqueous solution is 15%, the mixture of the crude oil and the aqueous solution of the copper chloride is poured into the separation installation. The aqueous solution of the copper chloride rapidly flows down through the inorganic phase separation membrane, and the crude oil is intercepted above the inorganic phase separation membrane. Stabilizing for 30 minutes, if the aqueous solution of the copper chloride does not drop down, and the crude oil does not permeate, the aqueous solution of the copper chloride and the crude oil are considered to be separated fully. After completing the separation, aqueous solution of sodium hydroxide is dripped into the aqueous solution of the copper chloride separated, and a blue flocculent precipitate is shown immediately, which proves that the aqueous solution of the copper chloride separated comprises copper ion.

### Example 18

The inorganic phase separation membrane prepared in the Example 2 is fixed on a polytetrafluoroethylene (PTFE) flange that is shown in FIG. 4a. Assembling a separation installation as shown in FIG. 4b, after stirring mixture of crude oil and aqueous solution of sodium chloride, wherein, a volume ratio of the crude oil to the aqueous solution of the sodium chloride is 1:1, and a mass fraction of the aqueous solution of the sodium chloride is 10%, the mixture of the crude oil and the aqueous solution of the sodium chloride is poured into the separation installation. The aqueous solution of sodium chloride rapidly flows down through the inorganic phase separation membrane, and the crude oil is intercepted above the inorganic phase separation membrane. Stabilizing for 30 minutes, if the aqueous solution of the sodium chloride does not drop down, and the crude oil does not permeate, the aqueous solution of the sodium chloride and the crude oil are considered to be separated fully. After completing the separation, silver nitrate solution is dripped into the aqueous solution of the sodium chloride separated, and a white flocculent precipitate is shown immediately, which proves that the aqueous solution of the sodium chloride separated comprises chloride ion.

### Example 19

The inorganic phase separation membrane prepared in the Example 2 is fixed on a polytetrafluoroethylene (PTFE) flange that is shown in FIG. 4a. Assembling a separation installation as shown in FIG. 4b, after stirring crude oil and aqueous solution of sodium hydroxide, wherein, a volume ratio of the crude oil to the aqueous solution of the sodium hydroxide is 1:1, and a mass fraction of the aqueous solution of the sodium hydroxide is 5%, the mixture of the crude oil and the aqueous solution of the sodium hydroxide is poured into the separation installation. The aqueous solution of the sodium hydroxide rapidly flows down through the inorganic phase separation membrane, and the crude oil is intercepted above the inorganic phase separation membrane. Stabilizing for 30 minutes, if the aqueous solution of the sodium hydroxide does not drop down, and the crude oil does not permeate, the aqueous solution of the sodium hydroxide and the crude oil are considered to be separated fully.

### Example 20

The inorganic phase separation membrane prepared in the Example 2 is calcined under 800 ° C. for removing viscous oil that may adhere. After cooling the inorganic phase separation membrane that is calcined, the separation experiment in the Example 11 is repeated, and a property of an oil-water separation is not affected.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

1. A inorganic phase separation membrane comprising a porous substrate and a molecular sieve coating that forms on said porous substrate, wherein, an aperture size of said porous substrate is 20 μm-200 μm; a thickness range of said molecular sieve coating is 3 μm-50 μm; a mass ratio of said porous substrate to said molecular sieve coating is 100:1-5:1; said porous substrate is a stainless steel mesh, a cooper mesh, an aluminum mesh, or a porous ceramic; and a framework type of a molecular sieve is LTA, SOD, FAU, MEL, CHA, MFI, DDR, AFI, BEA, or PHI.

2. A preparation method of the inorganic phase separation membrane, as recited in claim 1, comprising steps of:
(1). dipping a porous substrate into the aqueous solution of the nano-zeolite dispersed, wherein a mass fraction of aqueous solution of nano-zeolite dispersed is 2%-10%;
processing the porous substrate with an ultrasonic treatment for 5-30 minutes;
taking out the porous substrate;
drying the porous substrate under 40° C.-200° C. for 2-12 hours;
and repeating steps of dipping, processing with the ultrasonic treatment, and drying mentioned above for 2-10 times, in such a manner that the nano-zeolite equably disperse on the porous substrate; (2). vertically fixing the porous substrate in a hydrothermal reactor;
dipping the porous substrate into synthetic sol of the nano-zeolite that is used in the Step (1);
processing the porous substrate with a hydrothermal reaction under 40° C.-230° C. for 2-120 hours to process the nano-zeolite with a secondary growth;
and washing, drying, and flattening the porous substrate, in such a manner that an inorganic phase separation membrane is obtained.

3. A preparation method of the inorganic phase separation membrane, as recited in claim 1, comprising steps of:
vertically fixing a porous substrate in a hydrothermal reactor;
dipping the porous substrate into synthetic sol of nano-zeolite;
processing the porous substrate with a hydrothermal reaction under 40° C.-230° C. for 2-120 hours;
and washing, drying, and flattening the porous substrate, in such a manner that an inorganic phase separation membrane is obtained.

4. A preparation method of the inorganic phase separation membrane, as recited in claim 1, comprising steps of:
(1). dipping a porous substrate into the aqueous solution of the nano-zeolite dispersed, wherein a mass fraction of aqueous solution of nano-zeolite dispersed is 2%-10%,
processing the porous substrate with an ultrasonic treatment for 5-30 minutes;
taking out the porous substrate and drying the porous substrate under 40° C.-200° C. for 2-12 hours;
and repeating steps of dipping, processing with the ultrasonic treatment, and drying mentioned above for 2-10 times, in such a manner that the nano-zeolite equably disperse on the porous substrate;
(2). vertically fixing the porous substrate mentioned above in a hydrothermal reactor;
dipping the porous substrate into synthetic sol of the nano-zeolite that is used in the Step (1);
processing the porous substrate with a microwave heating under 60° C.-200° C. to react for 30-300 minutes;
and washing, drying, and flattening the porous substrate, in such a manner that an inorganic phase separation membrane is obtained.

5. A preparation method of the inorganic phase separation membrane, as recited in claim 1, comprises steps of:
vertically fixing a porous substrate in a hydrothermal reactor;
dipping the porous substrate into synthetic sol of nano-zeolite;
processing the porous substrate with a microwave heating under 60° C.-200° C. to react for 30-300 minutes;
and washing, drying, and flattening the porous substrate, in such a manner that an inorganic phase separation membrane is obtained.

6. A preparation method of the inorganic phase separation membrane, as recited in claim 1, comprising steps of:
(1). vertically fixing a porous substrate in a hydrothermal reactor;
dipping the porous substrate into synthetic sol of nano-zeolite for 2-48 hours;
taking out the porous substrate;
drying the porous substrate under 20° C.-100° C. for 2-72 hours;
and repeating processes of dipping, and drying mentioned above for 2-10 times;
(2). putting the porous substrate processed mentioned above in vapor phase with solvent and organic amine;
reacting the porous substrate under 80° C.-230° C. for 2-72 hours;
and washing, drying, and flattening the porous substrate, in such a manner that an inorganic phase separation membrane is obtained.

7-10. (canceled)

11. A method for separating an oil and water mixture, comprising:
filtering the oil and water mixture with the inorganic phase separation membrane according to claim 1.

12. The method for separating the oil and water mixture, as recited in claim 11, wherein, the oil and water mixture comprises oil phase and water phase; said oil phase is a group consisting of petroleum, rapessed oil, gasoline, diesel fuel, petroleum ether, cyclohexane, n-heptane, n-octane, n-butanol, ethyl acetate, benzene, dichloroethane, and chloroform.

13. The method for separating the oil and water mixture, as recited in claim 11, wherein, the oil and water mixture comprises oil phase and water phase; said water phase is a group consisting of aqueous solution of hydrochloric acid, aqueous solution of sulfuric acid, aqueous solution of nitric acid, aqueous solution of sodium hydroxide, aqueous solution of potassium hydroxide, aqueous solution of sodium chloride, aqueous solution of potassium chloride, aqueous solution of copper chloride, aqueous solution of ferric chloride, and aqueous solution of copper sulfate; a mass fraction of total solute of said water phase solution is 1%-65%.

14. The method for separating the oil and water mixture, as recited in claim 11, wherein water phase of the oil and water mixture occupies 5%-95% of a mixed volume of oil phase and said water phase.
